(19) United States
(12) Patent Application Publication
(10) Pub. No.: US 2024/0203143 A1
(43) Pub. Date: Jun. 20, 2024

(54) PROMPT TUNING FOR ZERO-SHOT COMPOSITIONAL LEARNING IN MACHINE LEARNING SYSTEMS

(71) Applicant: Samsung Electronics Co., Ltd., Suwon-si, Gyeonggi-do (KR)

(72) Inventors: Lingyu Zhang, Cupertino, CA (US); Ting Hua, Santa Clara, CA (US); Yilin Shen, Santa Clara, CA (US); Hongxia Jin, San Jose, CA (US)

(21) Appl. No.: 18/454,459

(22) Filed: Aug. 23, 2023

Related U.S. Application Data
(60) Provisional application No. 63/433,374, filed on Dec. 16, 2022.

(51) Int. Cl. G06V 20/70; G06F 40/284; G06V 10/774

(52) U.S. Cl. CPC G06V 20/70; G06F 40/284; G06V 10/774

(57) ABSTRACT

A method includes obtaining an image, a set of attribute labels, and a set of object labels and performing prompt tuning of a pre-trained vision-language model having first and second textual encoders and a vision encoder. The model is trained during prompt tuning to select one attribute label and one object label that match content in the image. Performing the prompt tuning includes, for each attribute label-object label pair, generating object textual features associated with the object label using the first textual encoder, generating attribute textual features associated with the attribute label using the second textual encoder, and generating image features associated with the image using the vision encoder. Intermediate outputs from initial layers of the textual encoders and the vision encoder are combined to generate layer-specific learnable prompt tokens that are appended to inputs of specified layers in the first and second textual encoders and the vision encoder.

### CROSS-REFERENCE TO RELATED APPLICATION AND PRIORITY CLAIM

This application claims priority under 35 U.S.C. § 119(e) to U.S. Provisional Patent Application No. 63/433,374 filed on Dec. 16, 2022. This provisional application is hereby incorporated by reference in its entirety.

### TECHNICAL FIELD

This disclosure relates generally to machine learning systems and processes. More specifically, this disclosure relates to prompt tuning for zero-shot compositional learning in machine learning systems.

### BACKGROUND

Human beings can typically understand new concepts by composing or combining parts of other previously-learned concepts, which is often referred to as “compositional generalization ability.” Compositional generalization ability is a fundamental trait that allows humans to understand novel concepts through composing learned knowledge. Compositional zero-shot learning (CZSL) aims to simulate this human intelligence in machine learning environments by having a machine learning model learn a relatively small number of known compositions and generalizing its recognition ability to unseen compositions.

### SUMMARY

This disclosure relates to prompt tuning for zero-shot compositional learning in machine learning systems.

In a first embodiment, a method includes obtaining an image, a set of attribute labels, and a set of object labels and performing prompt tuning of a pre-trained vision-language model having a first textual encoder, a second textual encoder, and a vision encoder. The pre-trained vision-language model is trained during the prompt tuning to select one of the attribute labels and one of the object labels that match content contained in the image. Performing the prompt tuning includes, for each of multiple attribute label-object label pairs, generating object textual features associated with the object label of the attribute label-object label pair using the first textual encoder, generating attribute textual features associated with the attribute label of the attribute label-object label pair using the second textual encoder, and generating image features associated with the image using the vision encoder. Intermediate outputs from initial layers of the first textual encoder, the second textual encoder, and the vision encoder are combined to generate layer-specific learnable prompt tokens that are appended to inputs of specified layers in the first textual encoder, the second textual encoder, and the vision encoder during the prompt tuning. In another embodiment, a non-transitory machine readable medium includes instructions that when executed cause at least one processor to perform the method of the first embodiment.

In a second embodiment, an apparatus includes at least one processing device configured to obtain an image, a set of attribute labels, and a set of object labels and to perform prompt tuning of a pre-trained vision-language model having a first textual encoder, a second textual encoder, and a vision encoder. The pre-trained vision-language model is trained during the prompt tuning to select one of the attribute labels and one of the object labels that match content contained in the image. To perform the prompt tuning, the at least one processing device is configured, for each of multiple attribute label-object label pairs, to generate object textual features associated with the object label of the attribute label-object label pair using the first textual encoder, generate attribute textual features associated with the attribute label of the attribute label-object label pair using the second textual encoder, and generate image features associated with the image using the vision encoder. The at least one processing device is configured to combine intermediate outputs from initial layers of the first textual encoder, the second textual encoder, and the vision encoder to generate layer-specific learnable prompt tokens that are appended to inputs of specified layers in the first textual encoder, the second textual encoder, and the vision encoder during the prompt tuning.

In a third embodiment, a method includes obtaining an image of an object and obtaining a set of attribute labels and a set of object labels. The method also includes selecting one of the attribute labels and one of the object labels associated with the object using a vision-language model having a first textual encoder, a second textual encoder, and a vision encoder. Selecting the one of the attribute labels and the one of the object labels associated with the object includes generating object textual features associated with each of the object labels using the first textual encoder, generating attribute textual features associated with each of the attribute labels using the second textual encoder, and generating image features associated with the image using the vision encoder. One or more layers in the first textual encoder, one or more layers in the second textual encoder, and one or more layers in the vision encoder are each associated with a layer-specific multi-modal shared prompt that is concatenated to an input for the layer. In another embodiment, an apparatus includes at least one processing device configured to perform the method of the third embodiment. In still another embodiment, a non-transitory machine readable medium includes instructions that when executed cause at least one processor to perform the method of the third embodiment.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a bodv temperature measuring device), a magnetic resource angiographv (MRA) device, a magnetic resource imaging (MRI) device, a computed tomographv (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gvro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technologv.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example architecture supporting prompt tuning for zero-shot compositional learning in a machine learning system according to this disclosure;

FIGS. 3 through 6 illustrate example use cases for zero-shot compositional learning in a machine learning system according to this disclosure;

FIG. 7 illustrates an example method for training a machine learning model to support zero-shot compositional learning according to this disclosure; and

FIG. 8 illustrates an example method for using a machine learning model trained to perform zero-shot compositional learning according to this disclosure.

### DETAILED DESCRIPTION

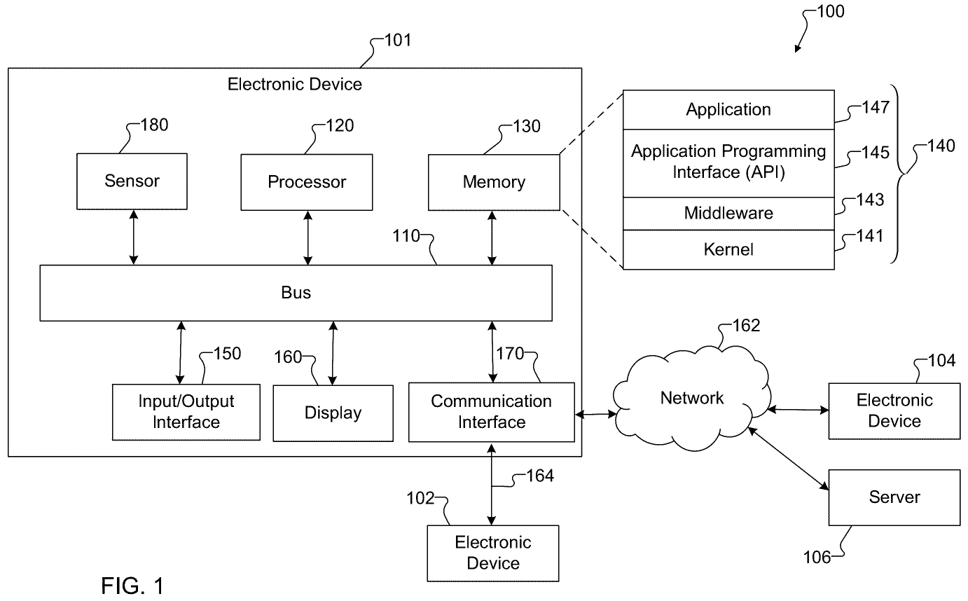

FIGS. 1 through 8, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, human beings can typically understand new concepts by composing or combining parts of other previously-learned concepts, which is often referred to as “compositional generalization ability.” Compositional generalization ability is a fundamental trait that allows humans to understand novel concepts through composing learned knowledge. Compositional zero-shot learning (CZSL) aims to simulate this human intelligence in machine learning environments by having a machine learning model learn a relatively small number of known compositions and generalizing its recognition ability to unseen compositions.

In a CZSL setting, each known composition may include a pair of labels identifying an object and an attribute of the object. For example, in an image of an old elephant, “old” is the attribute label, and “elephant” is the object label. A CZSL model can attempt to recognize compositions not seen before by decomposing known compositions contained in training data, such as by learning the new concept of an “old truck” after learning the concepts of an “old elephant” and a “new truck” from training data. However, this is a very challenging machine learning task. Among other reasons, different combinations of the same attribute label and object label can be associated with images having visual features with distinct shapes, colors, and textures. As particular examples, two instances of the same type of object can be fundamentally different in their visual features (such as “raw chicken” and “sliced chicken”). Similarly, the same attribute can look very different in two different objects (such as an “old truck” and an “old elephant”).

Existing CZSL models are often limited to a closed output space, where prior knowledge of unseen compositions is assumed during testing. As a result, significant performance drops can be observed when applying these CZSL models to more-realistic settings without limitations in the output search space. Large pre-trained machine learning models have shown potential in providing “common sense” knowledge to numerous downstream vision and language tasks. Large pre-trained vision-language models, such as contrastive language-image pre-training (CLIP) neural networks, are good candidates for tackling CZSL tasks, since CZSL tasks are often multi-modal and involve both textual and image-based inputs. However, despite their effectiveness, it is cost-expensive or cost-prohibitive to fine-tune these large pre-trained vision-language models due to their massive scales.

This disclosure provides various techniques for prompt tuning for zero-shot compositional learning in machine learning systems. As described in more detail below, an image, a set of attribute labels, and a set of object labels can be obtained, and prompt tuning of a pre-trained vision-language model can be performed. The image may include at least one object, the set of attribute labels may identify possible attributes of objects, and the set of object labels may identify possible types of objects. The pre-trained vision-language model can include a first textual encoder, a second textual encoder, and a vision encoder. The pre-trained vision-language model can be trained during the prompt tuning to select one of the attribute labels and one of the object labels that match content contained in the image. Performing the prompt tuning can include, for each of multiple attribute label-object label pairs, generating object textual features associated with the object label of the attribute label-object label pair using the first textual encoder, generating attribute textual features associated with the attribute label of the attribute label-object label pair using the second textual encoder, and generating image features associated with the image using the vision encoder. Intermediate outputs from initial layers of the first textual encoder, the second textual encoder, and the vision encoder can be combined to generate layer-specific learnable prompt tokens that are appended to inputs of specified layers in the first textual encoder, the second textual encoder, and the vision encoder during the prompt tuning.

The vision-language model trained as a result of the prompt tuning may be used in any suitable manner. For example, an image of an object can be obtained, and a set of attribute labels and a set of object labels can be obtained. One of the attribute labels and one of the object labels associated with the object can be selected using a vision-language model that includes a first textual encoder, a second textual encoder, and a vision encoder. Selecting the one of the attribute labels and the one of the object labels associated with the object can include generating object textual features associated with each of the object labels using the first textual encoder, generating attribute textual features associated with each of the attribute labels using the second textual encoder, and generating image features associated with the image using the vision encoder. One or more layers in the first textual encoder, one or more layers in the second textual encoder, and one or more layers in the vision encoder may each be associated with a layer-specific multi-modal shared prompt that is concatenated to an input for the layer.

In this way, multi-modal “prompt tuning” can be used to adapt a pre-trained vision-language model for one or more downstream tasks, such as one or more CZSL tasks. CZSL tasks often involve the use of rich knowledge to recognize unseen compositions, and tuning a large-scale pre-trained vision-language model can help to obtain high recognition performance and reduce or minimize training costs. Moreover, the number of parameters in certain large pre-trained vision-language models can be huge, and it can be cost-expensive or cost-prohibitive to perform full-model fine-tuning. The described techniques provide efficient mechanisms to fine-tune a large pre-trained vision-language model using multi-modal prompting, which can achieve good performance while maintaining low resource requirements for training.

Note that while some of the embodiments discussed below are described in the context of use in consumer electronic devices (such as smartphones, ovens, microwaves, refrigerators, washers, dryers, and steam cabinets), these are merely examples. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to using prompt tuning of a machine learning model for zero-shot compositional learning and/or use of a trained machine learning model to perform zero-shot compositional learning.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to training and/or use of a machine learning model. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a bodv portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a phvsical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gvroscope or gvro sensor, an air pressure sensor, a magnetic sensor or magnetometer, an acceleration sensor or accelerometer, a grip sensor, a proximity sensor, a color sensor (such as a red green blue (RGB) sensor), a bio-phvsical sensor, a temperature sensor, a humidity sensor, an illumination sensor, an ultraviolet (UV) sensor, an electromyographv (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gvroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to using prompt tuning of a machine learning model for zero-shot compositional learning and/or use of a trained machine learning model to perform zero-shot compositional learning.

Note that the electronic device 101 here may take various forms depending on the implementation. For example, in certain instances discussed in this patent document, it may be assumed that the electronic device 101 represents a portable consumer device, such as a smartphone, a tablet computer, or a virtual reality (VR)/augmented reality (AR)/extended reality (XR) headset. However, the electronic device 101 may take any other suitable forms, such as an oven, microwave, refrigerator, washer, dryer, or steam cabinet. In general, this disclosure is not limited to use with any specific type of device.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

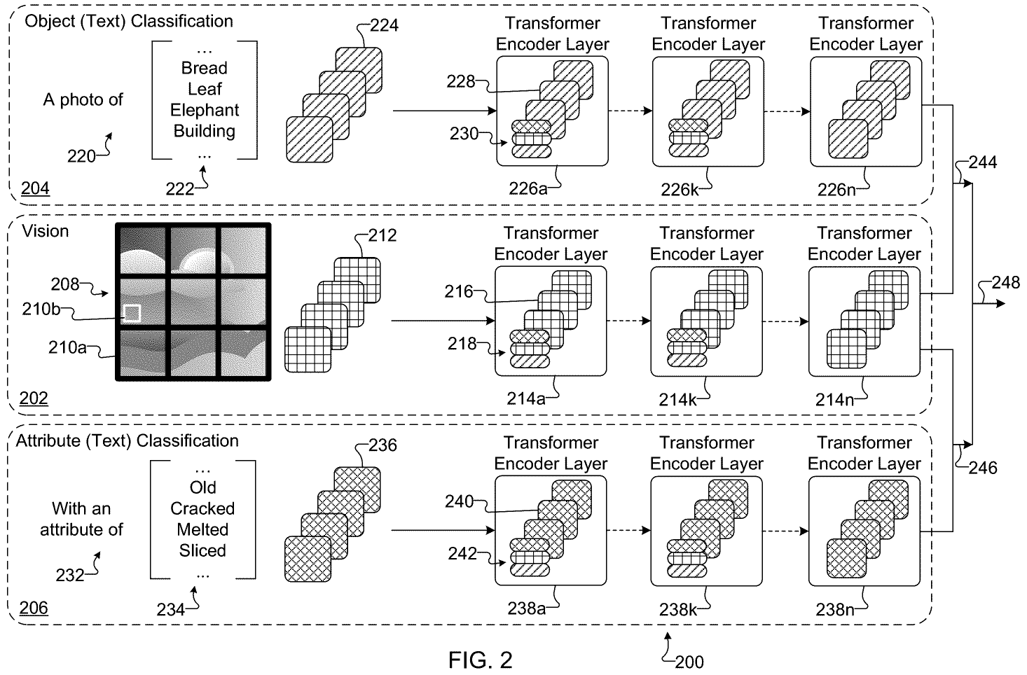

FIG. 2 illustrates an example architecture 200 supporting prompt tuning for zero-shot compositional learning in a machine learning system according to this disclosure. For ease of explanation, the architecture 200 shown in FIG. 2 is described as being used by the server 106 in the network configuration 100 shown in FIG. 1 in order to engage in prompt tuning of a large pre-trained vision-language model. However, the architecture 200 could be used by any other suitable device(s) (such as the electronic device 101) and in any other suitable system(s), and the architecture 200 may be used to train any other suitable machine learning model(s).

As shown in FIG. 2, the architecture 200 is used to support multi-modal prompt tuning that is applied to a pre-trained vision-language model, which allows the pre-trained vision-language model to be applied effectively to one or more CZSL tasks. The pre-trained vision-language model here may represent any suitable vision-language model, such as a CLIP model, a context optimization (CoOp) model, or a conditional context optimization (CoCoOp) model. As shown in FIG. 2, the architecture 200 implements the pre-trained vision-language model using a three-branch transformer-based machine learning model architecture, which can undergo multi-modal prompt tuning to align the pre-trained vision-language model to at least one specific CZSL task. In this example, a branch 202 of the architecture 200 implements a vision encoder, a branch 204 of the architecture 200 implements a first textual encoder, and a branch 206 of the architecture 200 implements a second textual encoder.

As shown here, the branch 202 of the architecture 200 receives an image 208 as input. The image 208 may optionally be divided into multiple patches 210a, which in some cases may be processed in parallel. As described below, a visual patch prompt 210b may also optionally be used to improve the generalization ability for the multi-modal prompt tuning. The vision encoder implemented by the branch 202 generally operates to extract visual features 212 from the image 208. For example, the vision encoder implemented by the branch 202 can be trained to learn which visual features 212 of the image 208 are relevant to a given task, and the vision encoder can extract those visual features 212 from each image 208 received by the vision encoder. The resulting visual features 212 are processed using multiple transformer encoder layers 214a-214n, which generate embeddings of the visual features 212 within an associated feature space. Each transformer encoder layer 214a-214n is associated with a collection of learnable parameters 216, such as weights that are applied to vectors processed by the transformer encoder layer 214a-214n. As described below, one or more initial transformer encoder layers 214a-214k in the vision encoder also receive one or more layer-specific shared prompts 218.

The branch 204 of the architecture 200 receives an input 220 that includes or identifies a set of object labels 222. The object labels 222 may represent a set of known object types, which may be generated or otherwise obtained in any suitable manner. For instance, the set of object labels 222 may be retrieved or derived from a set of textual categories in a knowledge base, which may have been previously learned and updated during an optimization process. The first textual encoder implemented by the branch 204 generally operates to extract object textual features 224 from the set of object labels 222. For example, the first textual encoder implemented by the branch 204 can be trained to learn which object textual features 224 are relevant to a given task, and the first textual encoder can extract those object textual features 224 from the set of object labels 222 received by the first textual encoder. The resulting object textual features 224 are processed using multiple transformer encoder layers 226a-226n, which generate embeddings of the object textual features 224 within an associated feature space. Each transformer encoder layer 226a-226n is associated with a collection of learnable parameters 228, such as weights that are applied to vectors processed by the transformer encoder layer 226a-226n. As described below, one or more initial transformer encoder layers 226a-226k in the first textual encoder also receive one or more layer-specific shared prompts 230.

The branch 206 of the architecture 200 receives an input 232 that includes or identifies a set of attribute labels 234. The attribute labels 234 may represent a set of known attribute types, which may be generated or otherwise obtained in any suitable manner. For instance, the set of attribute labels 234 may be retrieved or derived from a set of textual categories in the knowledge base, which may have been previously learned and updated during the optimization process. The second textual encoder implemented by the branch 206 generally operates to extract attribute textual features 236 from the set of attribute labels 234. For example, the second textual encoder implemented by the branch 206 can be trained to learn which attribute textual features 236 are relevant to a given task, and the second textual encoder can extract those attribute textual features 236 from the set of attribute labels 234 received by the second textual encoder. The resulting attribute textual features 236 are processed using multiple transformer encoder layers 238a-238n, which generate embeddings of the attribute textual features 236 within an associated feature space. Each transformer encoder layer 238a-238n is associated with a collection of learnable parameters 240, such as weights that are applied to vectors processed by the transformer encoder layer 238a-238n. As described below, one or more initial transformer encoder layers 238a-238k in the second textual encoder also receive one or more layer-specific shared prompts 242.

In some embodiments, an object score 244 can be generated for each object label 222, such as by identifying the similarity between embeddings of the visual features 212 generated by a final transformer encoder layer 214n of the vision encoder (branch 202) and embeddings of the object textual features 224 associated with the object label 222 generated by a final transformer encoder layer 226n of the first textual encoder (branch 204). The object label 222 associated with the highest object score may be selected as the object label 222 representing a type of object contained in the image 208. Similarly, an attribute score 246 can be generated for each attribute label 234, such as by identifying the similarity between the embeddings of the visual features 212 generated by the final transformer encoder layer 214n of the vision encoder (branch 202) and embeddings of the attribute textual features 236 associated with the attribute label 234 generated by a final transformer encoder layer 238n of the second textual encoder (branch 206). The attribute label 234 associated with the highest attribute score may be selected as the attribute label 234 representing an attribute of an object contained in the image 208. The selected object label 222 and the selected attribute label 234 may be combined or otherwise used to generate an output 248 of the architecture 200.

In the architecture 200, the various branches 202, 204, 206 support the use of prompt tuning, which generally involves appending additional data to inputs provided to one or more initial transformer encoder layers 214a-214k, 226a-226k, 238a-238k in each of the branches 202, 204, 206. The additional data can be defined based on the downstream task(s) to be performed so that the large pre-trained vision-language model can better understand the downstream task(s). Examples of downstream tasks may include image-text retrieval, visual question answering, or visual grounding. The use of prompt tuning allows the pre-trained vision-language model to achieve considerable performance improvements without requiring additional training of the entire pre-trained vision-language model. As can be seen in FIG. 2, instead of each branch 202, 204, and 206 using prompts of a single modality, the shared prompts 218, 230, and 242 may be used across the vision and textual encoders, which supports multi-modal prompt tuning that can bridge the gaps between the different visual and language modalities. Again, visual patch prompts 210b may be added to further improve the generalization ability for the multi-modal prompt tuning.

The following now provides an explanation for how the architecture 200 can be used in some embodiments to support multi-modal prompt tuning. Note that this explanation relates to specific implementations of the architecture 200 and that other implementations of the architecture 200 may be used. One goal of compositional zero-shot learning can be to recognize a composition of multiple concepts (such as an object and an attribute) contained in a given image 208. For instance, each sample in a training dataset

$${𝒯}_{train} = {\{ ( x , c ) \}}_{i = 1}^{M}$$

contain an image sample x and a composition c, where x E [symbol] is an element in an image space [symbol] and c=(a, o) is a composition label that includes an attribute label a and an object label o. Given the set 222 of object labels [symbol] and the set 234 of attribute labels [symbol] , a complete composition set [symbol] can be constructed as

$$𝒞 = 𝒜 \times 𝒪 = \{ ( a , o ) \vert a ∈ 𝒜 , o ∈ 𝒪 \} .$$

All compositions appearing in the training dataset form a “seen” composition set [symbol] which is a subset of the complete composition set [symbol] . Compositions not appearing in the training dataset form an “unseen” composition set [symbol] which is a subset of the complete composition set C and possibly a much larger subset than the “seen” composition set [symbol] The difficulties of various CZSL tasks can be quite different depending on the output space of predictions to be generated using a machine learning model. For instance, given a new image x, a prediction for the image x generated by a machine learning model may be denoted as ĉ, and various learning scenarios can be defined as follows:

$$supervised learnin \text{g:} \hat{c} ∈ {𝒞}^{s} ; \\ zero ‐ shot learnin \text{g:} \hat{c} ∈ {𝒞}^{u} ; \\ generalized zero ‐ shot learnin \text{g:} \hat{c} ∈ {𝒞}^{s} ⋃ {𝒞}^{u} ; and \\ open ‐ world zero ‐ shot learnin \text{g:} \hat{c} ∈ 𝒞 .$$

In a standard zero-shot learning setting, only the unseen compositions [symbol] are predicted during testing. However, recent CZSL work considers the generalized scenario in which testing samples can come from either the seen composition set [symbol] or the unseen composition set [symbol] Compared to standard zero-shot learning, this is more challenging since the machine learning model will naturally be biased towards the seen compositions. The most challenging case is open-world compositional zero-shot learning (OW-CZSL), where testing samples can be drawn from the whole composition set C. In this case, the output space is so large that it can hardly be generalized from the small number of seen compositions (meaning [symbol] ). The most challenging OW-CZSL scenario that has no prior assumptions on the unseen composition set during testing is discussed here.

Multi-modal prompt tuning (MMPT) performed using the architecture 200 involves the use of both vision prompts and textual prompts. More specifically, MMPT involves the use of the three branches 202, 204, and 206, one for vision and two for object and attribute text. In some embodiments, a vision transformer (ViT) may be used in the branch 202 as the backbone, and both of the branches 204 and 206 may use language transformers as encoders. To enable multi-modal prompt tuning, the shared prompts 218, 230, and 242 are introduced into the respective input spaces at one or more initial layers of each of the branches 202, 204, and 206. Here, for the i^{th} transformer encoder layer 214a-214k, 226a-226k, 238a-238k of each branch 202, 204, 206, an input learnable prompt is denoted as tᵢ ∈ [symbol] which is a vector with dimension d. The dimension of an image embedding E in the vision encoder is denoted as d_{ν} (which is some cases may have a value of 768), and the dimension of a word embedding W in each object and attribute textual encoder is denoted as dₗ (which is some cases may have a value of 512). A mutual prompt tᵢ can be shared across multiple modalities and in some cases may have a length of six. To share the mutual prompt tᵢ across multiple modalities, a projection function g_{ν} (tᵢ): [symbol] is used to map the shared prompt tᵢ to learnable parameters in the vision encoder (branch 202). Similarly, projection functions gₒ(tᵢ): [symbol] and gₐ(tᵢ): [symbol] are respectively used to map the shared prompt tᵢ to learnable parameters in the object and attribute textual encoders (branches 204 and 206).

In the input layer of the vision encoder, the j^{th} patch 210a of an image x is denoted as x^{(j)} and is embedded into a d_{ν}-dimensional vector. Additionally, a visual patch prompt 210b can be added, which may represent a learnable vector parameterized by ϕ. In some cases, the visual patch prompt 210b can be initialized with a random size and/or a random location within the image x. As a particular example, the image x may have a resolution of 224 pixels by 224 pixels, and the visual patch prompt 210b may have a size of 16 pixels by 16 pixels (although these values are examples only). One or more initial embeddings generated by the vision encoder can be expressed as follows.

$${E}_{0} = {\{ {e}_{0}^{j} \}}_{j = 1}^{K} = {\{ Embedding ( {x}^{( j )} + ϕ ) \}}_{j = 1}^{K} \qquad ( 1 )$$

Here, K represents the number of patches 210a in the image 208. A learnable shared prompt g_{ν} (tᵢ) can be injected into the input space of the i^{th} transformer encoder layer of the branch 202, together with a learned embedding

$${E}_{i - 1} = {\{ {e}_{i - 1}^{j} ∈ {ℝ}^{{d}_{v}} \}}_{j = 1}^{K}$$

from a preceding layer and a hidden feature zᵢ₋₁ that encodes a learnable attribute token and object token. This process can be expressed as follows.

$$[ {E}_{i} , {z}_{i} ] = {L}_{i}^{( v )} ( [ {g}_{v} ( {t}_{i} ) , {E}_{i - 1} , {z}_{i - 1} ] ) , 1 ⩽ i ⩽ {h}_{s} \qquad ( 2 )$$

Here, [·,·] represents a concatenation operation on multiple vectors, and Lᵢ^{(ν)} represents the i^{th} transformer encoder layer in the branch 202. Note that only the first k transformer encoder layers 214a-214k in the branch 202 have layer-specific shared prompts 218. Each subsequent transformer encoder layer in the branch 202 (starting from transformer encoder layer k+1) can process one or more embeddings and one or more prompts from the previous layer, which may be expressed as follows.

$$[ {G}_{j}^{( v )} , {E}_{i} , {z}_{j} ] = {L}_{j}^{( v )} ( [ {G}_{j - 1}^{( v )} , {E}_{j - 1} , {z}_{j - 1} ] ) , {h}_{s} < j ⩽ {h}_{v} \qquad ( 3 )$$

Here, h_{ν} represents the total number of transformer encoder layers 214a-214n in the branch 202, and hₛ equals k. As j starts from hₛ+1, the initial value of Gₕ_{ₛ}^{(ν)} is equal to g_{ν} (tₕ_{ₛ}). In some embodiments, layer-specific shared prompts are not injected into all transformer encoder layers of the branch 202. In particular embodiments, the branch 202 may include a total of twelve transformer encoder layers 214a-214n, and nine of the transformer encoder layers 214a-214k may receive layer-specific shared prompts 218 (although these values are examples only).

As noted above, the shared prompt tᵢ can be projected for the textual encoders (branches 204 and 206) using the projection functions gₒ(tᵢ) and gₐ(tᵢ). The initial transformer encoder layer 238a of the branch 206 generates word embeddings Wₒ^{(a)} ∈ [symbol] from text. For each subsequent transformer encoder layer i of the branch 206, the inputs include a layer-specific shared prompt gₐ (tᵢ), fixed embeddings Wᵢ₋₁, and an attribute token yᵢ₋₁^{(a)} from the previous layer. This can be expressed as follows.

$$[ {W}_{i}^{( a )} , {y}_{i}^{( a )} ] = {L}_{i}^{( a )} ( [ {g}_{a} ( {t}_{i} ) , {W}_{i - 1}^{( a )} , {y}_{i - 1}^{( a )} ] ) , 1 ⩽ i ⩽ {h}_{s} \qquad ( 4 )$$

Similar to the operations of the branch 202 shown in Equation (2) and (3) above, after the k^{th} transformer encoder layer 238k, the branch 206 can reuse one or more prompts learned from the previous layer as its input prompt(s), along with one or more embeddings from the previous layer. This can be expressed as follows.

$$[ {G}_{j}^{( a )} , {W}_{i}^{( a )} , {y}_{i}^{( a )} ] = {L}_{i}^{( a )} ( [ {G}_{j - 1}^{( a )} , {W}_{j - 1}^{( a )} , {y}_{j - 1}^{( a )} ] ) , {h}_{s} < j ⩽ {h}_{a} \qquad ( 5 )$$

Here, hₐ represents the total number of transformer encoder layers 238a-238n in the branch 206, and Gₕ_{ₛ}^{(a)}=gₐ (tₕ_{ₛ}) represents the prompt(s) directed forwarded. In particular embodiments, the branch 206 may include a total of twelve transformer encoder layers 238a-238n, and nine of the transformer encoder layers 238a-238k may receive layer-specific shared prompts 242 (although these values are examples only).

The branch 204 may operate in a similar manner. For example, the initial transformer encoder layer 226a of the branch 204 generates word embeddings Wₒ^{(o)}∈ [symbol] from text. For each subsequent transformer encoder layer i of the branch 204, the inputs include a layer-specific prompt gₒ(tᵢ), fixed embeddings Wᵢ₋₁, and an object token yᵢ₋₁^{(o)} from the previous layer. This can be expressed as follows.

$$[ {W}_{i}^{( o )} , {y}_{i}^{( o )} ] = {L}_{i}^{( o )} ( [ {g}_{o} ( {t}_{i} ) , {W}_{i - 1}^{( o )} , {y}_{i - 1}^{( o )} ] ) , 1 ⩽ i ⩽ {h}_{s} \qquad ( 6 )$$

After the k^{th} transformer encoder layer 226k, the branch 204 can reuse one or more prompts learned from the previous layer as its input prompt(s), along with one or more embeddings from the previous laver. This can be expressed as follows.

$$[ {G}_{j}^{( o )} , {W}_{i}^{( o )} , {y}_{i}^{( o )} ] = {L}_{i}^{( o )} ( [ {G}_{j - 1}^{( o )} , {W}_{j - 1}^{( o )} , {y}_{j - 1}^{( o )} ] ) , {h}_{s} < j ⩽ {h}_{a} \qquad ( 7 )$$

Here, hₒ represents the total number of transformer encoder layers 226a-226n in the branch 204, and Gₕ_{ₛ}^{(o)}=gₒ(tₕ_{ₛ}) represents the prompt(s) directed forwarded. In particular embodiments, the branch 204 may include a total of twelve transformer encoder layers 226a-226n, and nine of the transformer encoder layers 226a-226k may receive layer-specific shared prompts 230 (although these values are examples only).

The outputs of the final transformer encoder layers 214n and 226n in the branches 202 and 204 can be combined as noted above to produce object scores 244 for the object labels 222. Also, the outputs of the final transformer encoder layers 214n and 238n in the branches 202 and 206 can be combined as noted above to produce attribute scores 246 for the attribute labels 234. In some cases, the object scores 244 and the attribute scores 246 respectively represent probabilities that the individual object labels 222 and attribute labels 234 are present within the image 208. As a particular example, take the prediction of which attribute label 234 should be selected as being present within an image x. For a specific attribute a*, its probability over the image x may be determined as follows.

$${ρ}_{a} ( a = {a}^{*} , z = {z}_{{h}_{v}} ) = \frac{exp ( cos ( ω ( {y}_{{h}_{a}}^{( {a}^{*} )} ) , v ( {z}_{{h}_{v}} ) ) / τ )}{{\sum }_{a ∈ 𝒜} exp ( cos ( ω ( {y}_{{h}_{a}}^{( a )} ) , v ( {z}_{{h}_{v}} ) ) / τ )} \qquad ( 8 )$$

Here, βₐ represents the attribute score 246 for the specific attribute label 234, and cos(·) represents cosine similarity. Also, ω(·) and ν(·) represent the projection functions, and zₕ_{_{ν}} represents the output vector from the final transformer encoder layer 214n in the vision encoder. Further, yₕ_{_{α}}^{(α)} represents an attribute token from the final transformer encoder layer 238n of the second textual encoder, and τ represents a fixed temperate parameter. The object score 244 for each object label 222 may be determined using similar calculations, such as in the following manner.

$${ρ}_{o} ( o = {o}^{*} , z = {z}_{{h}_{v}} ) = \frac{exp ( cos ( ω ( {y}_{{h}_{o}}^{( {o}^{*} )} ) , v ( {z}_{{h}_{v}} ) ) / τ )}{{\sum }_{o ∈ 𝒪} exp ( cos ( ω ( {y}_{{h}_{o}}^{( o )} ) , v ( {z}_{{h}_{v}} ) ) / τ )} \qquad ( 9 )$$

Here, ρₒ represents the object score 244 for a specific object label 222, and yₕ_{ₒ}^{(o)} represents an object token from the final transformer encoder layer 226n of the first textual encoder.

In this way, a model with a pre-trained vision-language backbone can be trained during multi-modal prompt tuning using various images 208 containing objects associated with a subset of all possible attribute label-object label pairs. The multi-modal prompt tuning is performed here by (among other things) taking intermediate outputs from one or more initial transformer encoder layers 214a-214k of the vision encoder, one or more initial transformer encoder layers 226a-226k of the first textual encoder, and one or more initial transformer encoder layers 238a-238k of the second textual encoder and combining those intermediate outputs to create layer-specific learnable prompt tokens (represented or based on the shared prompts 218, 230, and 242). These layer-specific learnable prompt tokens can be appended to inputs of subsequent layers in each of the vision encoder, the first textual encoder, and the second textual encoder during the prompt tuning. The vision encoder here can also process each image 208 using a learnable visual patch prompt 210b, which can be added to the image 208 and moved within the image 208 during the prompt tuning. After the multi-modal prompt tuning is complete, the vision-language model can be configured to evaluate additional images 208 in a zero-shot manner in order to identify objects within the additional images 208, including those objects that are associated with attribute label-object label pairs not seen during the multi-modal prompt tuning.

The architecture 200 can therefore use shared multi-modal prompting, which can help to promote better model guidance. For example, the architecture 200 supports the use of prompts from both vision and textual modalities. For the vision modality, vision prompts can be employed in the form of the visual patch prompts 210b in the images 208, which can help to provide guidance to a certain local area within each image 208 that contains the most distinguishable visual features for object-attribute understanding. Thus, for instance, the architecture 200 can conduct prompting in pixel space and in fused embedding space in order to steer the pre-trained vision-language model and better understand where focus should be placed within images 208. For the textual modalities, the object and attribute labels (which can represent object and attribute category names) can be concatenated at initial stages in the branches 202, 204, 206 and may be generally updated into pseudo-soft prompts during training to provide semantic meanings to be aligned with perceived visual features. The prompts from the vision and textual modalities can be fused and re-injected into corresponding feature representation learning networks (the branches 202, 204, and 206) for improved cross-modality alignment. Through this multi-modal shared prompting process, better guidance can be provided for the pre-trained vision-language model to find optimized object-attribute labels.

Moreover, the architecture 200 supports progressive deep prompting that enables effective and parameter-efficient model tuning. That is, the described techniques can be used to inject an additional learnable token into each of various transformer encoder layers 214a-214k, 226a-226k, 238a-238k in the branches 202, 204, 206. The remaining parameters in the pre-trained vision-language model can remain unchanged and may not be updated during prompt tuning. Among the three branches 202, 204, 206, intermediate outputs from earlier layers in the branches 202, 204, 206 can be fused and serve as inputs to subsequent layers. The fusion of vision and language features can be done in this progressive manner by learning from the training data so that the subsequent layers provide finer descriptions of cross-modal feature representations, thereby boosting model performance on recognizing unseen compositions. On the other hand, while the prompting can be performed in every transformer encoder layer 214a-214n, 226a-226n, 238a-238n, only one token may be tuned at a time during this process, so this allows the learning cost to be low and results in a novel parameter-efficient model tuning process that maintains high performance.

In addition, the architecture 200 supports the use of a triple-branch model and the use of a multi-task learning strategy that enable open-world exploration for improved or optimal object-attribute recognition. For example, in each branch 202, 204, 206 of the triple-branch framework, clues from other branches can be used to assist feature understanding in that branch. Also, a final object label prediction and a final attribute label prediction can be independent from each other, and every possible object label-attribute label combination may be considered based on given input images 208. This gives the architecture 200 the ability to discover rarely-seen object-attribute combinations, thereby boosting its performance for hard cases.

Note that in the architecture 200, the branches 204 and 206 can be viewed as two separate machine learning classifiers, one of which performs classification to select one of the object labels 222 and another of which performs classification to select one of the attribute labels 234 for an image 208. For example, the branch 204 can be used to select the object label 222 having the highest object score 244, and the branch 206 can be used to select the attribute label 234 having the highest attribute score 246. In some embodiments, the two machine learning classifiers can be jointly trained using a loss function that combines losses associated with the machine learning classifiers. As a particular example, the following loss function may be used during prompt tuning.

$$ℒ = {ℒ}_{o} + {ℒ}_{a} = - \frac{1}{\vert T \vert} {\sum }_{\{ x , ( a , o ) \} ∈ T} ( {log}_{{ρ}_{o}} ( o , z ) + {log}_{{ρ}_{a}} ( a , z ) ) \qquad ( 10 )$$

Here, L represents the total loss, Lₒ represents the loss associated with object label classification, and Lₐ represents the loss associated with attribute label classification. As shown in Equation (10), during prompt tuning, the cross-entropy losses for the attribute and object branches 204 and 206 can be minimized.

After prompt tuning is complete and the machine learning model is placed into use for inferencing, additional images 208 can be received and processed in order to identify object label-attribute label pairs for objects contained in the additional images 208. During inferencing, all possible compositions (meaning all possible object label-attribute label pairs) can be considered, and the object label-attribute label pair with the highest score can be used as the prediction for any given additional image 208. In some embodiments, the operations during inferencing may be expressed as follows.

$$\hat{c} = {arg max}_{( a , o ) ∈ 𝒞} {ρ}_{o} ( o , z ) {ρ}_{a} ( a , z ) \qquad ( 11 )$$

Here, z represents the visual features 212 extracted from a given image x using the vision encoder. For OW-CZSL, the searching space of outputs is the full composition set [symbol] , where most compositions are not seen in training data used to train the machine learning model.

Note that it is often assumed above that the complete set of object labels 222 and the complete set of attribute labels 234 are considered when processing images 208 and generating predictions of the images' contents. However, this need not be the case. For example, a user of an electronic device 101 may set user preferences indicating that some (but not all) object labels 222 and/or some (but not all) attribute labels 234 should be used when identifying contents in images 208. As particular examples, the user may be allowed to customize his or her preferences regarding major attribute categories that the user would like the machine learning model to recognize, such as when the user prefers that the model recognize material, state, and texture attributes of objects while ignoring color and pose attributes of objects. This can help to save time when generating classification results and make the overall system clearer and more concise. This is one example of how the proposed machine learning model can be extended to recognize attributes at customized granularity levels for improved user experiences.

It should be noted that the functions shown in FIG. 2 or described above can be implemented in an electronic device 101, 102, 104, server 106, or other device(s) in any suitable manner. For example, in some embodiments, at least some of the functions shown in FIG. 2 or described above can be implemented or supported using one or more software applications or other software instructions that are executed by the processor 120 of the electronic device 101, 102, 104, server 106, or other device(s). In other embodiments, at least some of the functions shown in FIG. 2 or described above can be implemented or supported using dedicated hardware components. In general, the functions shown in FIG. 2 or described above can be performed using any suitable hardware or any suitable combination of hardware and software/firmware instructions. Also, the functions shown in FIG. 2 or described above can be performed by a single device or by multiple devices.

Although FIG. 2 illustrates one example of an architecture 200 supporting prompt tuning for zero-shot compositional learning in a machine learning system, various changes may be made to FIG. 2. For example, various components or functions shown in FIG. 2 may be combined, further subdivided, rearranged, replicated, or omitted and additional components or functions can be added according to particular needs. Also, while it is assumed in FIG. 2 that each branch 202, 204, 206 includes the same number (n) of transformer encoder layers, this need not be the case, and each branch 202, 204, 206 may include any suitable number of transformer encoder layers. Further, while it is assumed in FIG. 2 that each branch 202, 204, 206 includes the same number (k) of initial transformer encoder layers that receive shared prompts, this need not be the case, and each branch 202, 204, 206 may include any suitable number of transformer encoder layers that receive shared prompts.

In addition, while shown as having three branches 202, 204, 206, the architecture 200 may include more than three branches, such as by including one or more additional branches that consider one or more additional modalities. As a particular example, another branch may be included in the architecture 200 for processing audio signals, where the architecture 200 can be used to fine-tune a pre-trained vision-language model to combine information in the vision, textual, and audio branches in order to understand more fine-grained details of objects and attributes. For instance, by deploying the pre-trained vision-language model into an intelligent microwave oven, it is possible for the pre-trained vision-language model to recognize fully-cooked popcorn in the microwave oven (and possibly remind a user of food status automatically) based on inputs that include images and audio recording segments like audio of “popping” sounds.

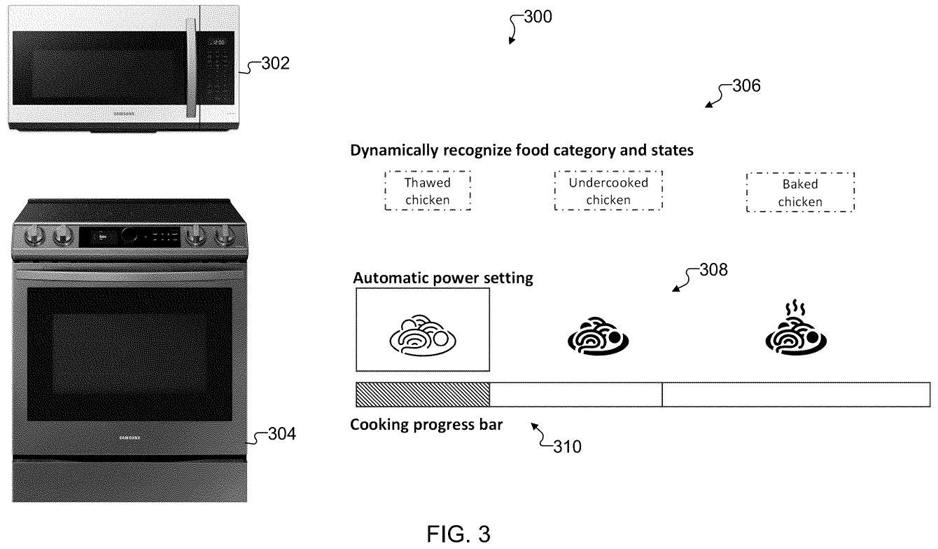

FIGS. 3 through 6 illustrate example use cases for zero-shot compositional learning in a machine learning system according to this disclosure. For ease of explanation, the use cases shown in FIGS. 3 through 6 are described as representing examples of how the architecture 200 may be used after prompt tuning has been completed. However, the architecture 200 may be used in any other suitable manner.

As shown in FIG. 3, a food cooking device like a microwave oven 302 or a traditional oven 304 can use (or be used in conjunction with) the architecture 200 to estimate food cooking status and perform one or more actions based on the food cooking status. For example, one or more cameras or other imaging sensors 180 may be used within or otherwise in association with the microwave oven 302 or traditional oven 304 in order to capture images of food that is cooking or to be cooked. The architecture 200 can be used to select an object label 222 and an attribute label 234 that are associated with a current state of a specific type of food. For instance, the selected object label 222 may identify a specific type of food being cooked, and the attribute label 234 may identify the current cooking state of the food. The architecture 200 can be trained using various basic compositions (such as “raw potato,” “thawed pizza,” and “baked chicken”), and the architecture 200 can automatically understand novel concepts about fine-grained states of food (such as “baked bread,” “thawed chicken,” or “baked pizza”). This enables the architecture 200 to make a dynamic recognition 306 of a food category and state. From this, the processor 120 may perform or initiate performance of one or more actions, such as dynamically controlling cooking of the food (like altering a remaining or total cooking time, adjusting a temperature, or ending cooking). In this example, the processor 120 may automatically adjust a power setting 308 of the microwave oven 302 or traditional oven 304. The processor 120 may also or alternatively control at least one notification of cooking status, such as by updating a cooking progress bar 310 to indicate how well the food has been cooked at the current time. Note that while a microwave oven 302 and a traditional oven 304 are shown here, any other suitable cooking devices may be used, such as an air fryer, bread maker, toaster oven, or other device. This type of approach can significantly increase the user's experience with the cooking devices.

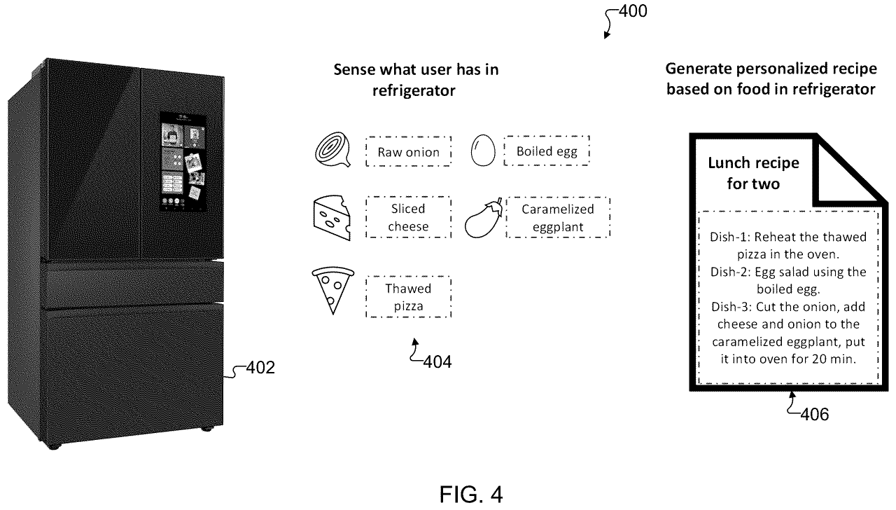

As shown in FIG. 4, a food storage device like a refrigerator 402 can use (or be used in conjunction with) the architecture 200 to identify stored foods and perform one or more actions based on the identified foods. For example, one or more cameras or other imaging sensors 180 may be used within or otherwise in association with the refrigerator 402 in order to capture images of food within the refrigerator 402. The architecture 200 can be used to select an object label 222 and an attribute label 234 that are associated with each identified food item. For instance, the selected object label-attribute label combination for each food item can identify a type of food and its current state. This enables the architecture 200 to make dynamic recognitions 404 of food items that are available for use. From this, the processor 120 may generate one or more recipes 406 that can be presented to a user, such as when presented on a display of the refrigerator 402 or when sent to a mobile device used by the user. The recipe 406 can include various ingredients, as least some of which are available within the refrigerator 402. Note that using only object labels may be inadequate here since it is possible for certain types of food items to be present within the refrigerator 402 while having attributes that do not allow for usage of the food items in certain recipes. This type of approach can increase cooking efficiency and reduce food waste.

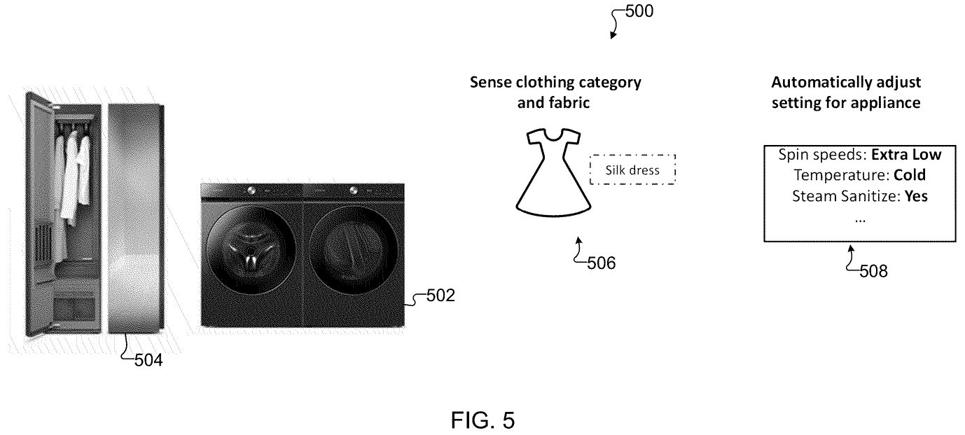

As shown in FIG. 5, a clothing cleaning device like a washer/dryer 502 (individually or in combination) or steam cabinet 504 can use (or be used in conjunction with) the architecture 200 to identify specific clothing items to be cleaned and perform one or more actions based on the identified clothing items. For example, one or more cameras or other imaging sensors 180 may be used within or otherwise in association with the washer/dryer 502 or steam cabinet 504 in order to capture images of clothing items to be cleaned. The architecture 200 can be used to select an object label 222 and an attribute label 234 that are associated with each identified clothing item. For instance, the selected object label-attribute label combination for each clothing item can identify a type of clothing item and a fabric or material used in the clothing item, such as cotton shirts, wool coats, leather jackets, or silk dresses. This enables the architecture 200 to make dynamic recognitions 506 of clothing items to be cleaned. From this, the processor 120 may generate one or more recommendations 508 identifying one or more settings for the washer/dryer 502 or steam cabinet 504. The one or more recommendations 508 may be presented to a user (such as when presented on a display of the washer/dryer 502 or steam cabinet 504) or used to automatically set or change one or more settings of the washer/dryer 502 or steam cabinet 504. This can help facilitate usage of proper settings for different materials of different clothes.

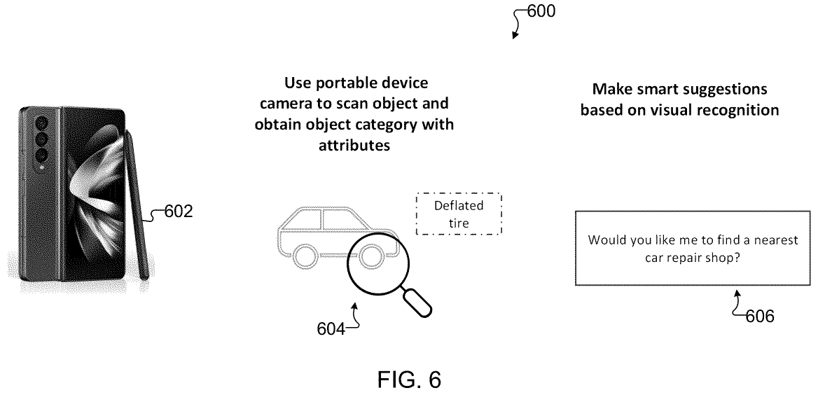

As shown in FIG. 6, a user's mobile device like a smartphone 602 or tablet computer can use (or be used in conjunction with) the architecture 200 to identify specific objects in particular states and perform one or more actions based on the identified objects and states. For example, one or more cameras or other imaging sensors 180 may be used to capture images of objects, and the architecture 200 can be used to select an object label 222 and an attribute label 234 that are associated with each object. For instance, the selected object label-attribute label combination for each object can identify a type of object and a state of the object. This enables the architecture 200 to make a dynamic recognition 604 of an object and its state. From this, the processor 120 may generate one or more recommendations 606 based on the object and its state. As particular examples, the architecture 200 may be used to recognize “fresh salmon,” “damp clothes,” or “deflated tire,” and these visual understanding results can be used to make smart recommendations 606 like “find the nearest car repair shop” or to connect with a smart home control system to ask if the user wants to “preheat the oven to” a specified temperature or perform other actions. The one or more recommendations 606 may be presented to a user (such as when presented on a display of the smartphone 602) or used to automatically perform or initiate one or more actions.

Although FIGS. 3 through 6 illustrate examples of use cases for zero-shot compositional learning in a machine learning system, various changes may be made to FIGS. 3 through 6. For example, zero-shot compositional learning may be used in any other suitable manner, and FIGS. 3 through 6 do not limit the use of zero-shot compositional learning to the specific example use cases shown here and described above.

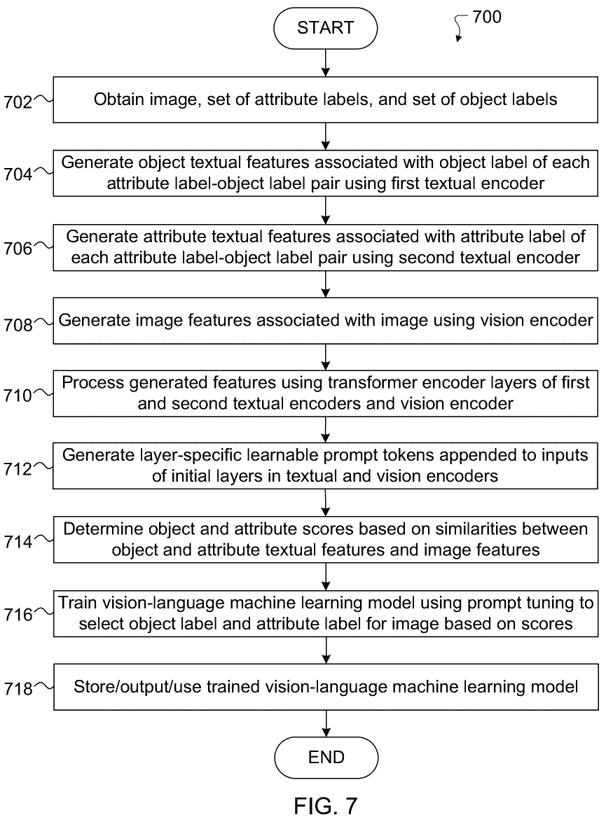

FIG. 7 illustrates an example method 700 for training a machine learning model to support zero-shot compositional learning according to this disclosure. For ease of explanation, the method 700 is described as being performed by the server 106 in the network configuration 100 shown in FIG. 1 using the architecture 200 shown in FIG. 2. However, the method 700 may be performed using any other suitable device(s) (such as the electronic device 101) and in any other suitable system(s), and the method 700 may be used with any other suitable machine learning architecture.

As shown in FIG. 7, an image, a set of attribute labels, and a set of object labels are obtained at step 702. This may include, for example, the processor 120 of the server 106 obtaining an image 208 from a repository of training data or other suitable source. This may also include the processor 120 of the server 106 obtaining one or more sets of textual categories from a knowledge base, where the textual categories include or are used to derive a set of object labels 222 and a set of attribute labels 234.

Prompt tuning of a pre-trained vision-language model is performed, where the pre-trained vision-language model includes a first textual encoder, a second textual encoder, and a vision encoder. For instance, object textual features associated with an object label of each of multiple attribute label-object label pairs are generated using the first textual encoder at step 704, and attribute textual features associated with an attribute label of each of the attribute label-object label pairs are generated using the second textual encoder at step 706. This may include, for example, the processor 120 of the server 106 using the first textual encoder implemented by the branch 204 of the architecture 200 to generate object textual features 224 from the set of object labels 222. This may also include the processor 120 of the server 106 using the second textual encoder implemented by the branch 206 of the architecture 200 to generate attribute textual features 236 from the set of attribute labels 234. Image features associated with the image are generated using the vision encoder at step 708. This may include, for example, the processor 120 of the server 106 using the vision encoder implemented by the branch 202 of the architecture 200 to generate visual features 212 from the image 208.

The generated features are processed using transformer encoder layers of the textual and vision encoders at step 710. This may include, for example, the processor 120 of the server 106 processing the visual features 212 using the transformer encoder layers 214a-214n of the branch 202, processing the object textual features 224 using the transformer encoder layers 226a-226n of the branch 204, and processing the attribute textual features 236 using the transformer encoder layers 238a-238n of the branch 206. As part of the processing, layer-specific learnable prompt tokens are generated and appended to inputs of specified layers in the textual and vision encoders at step 712. This may include, for example, the processor 120 of the server 106 using the techniques described above to generate shared prompts 218, 230, and 242, which can be provided to the transformer encoder layers 214a-214k, 226a-226k, 238a-238k in each of the branches 202, 204, 206.

Object scores are generated based on similarities between the object textual features and the image features, and attribute scores are generated based on similarities between the attribute textual features and the image features at step 714. This may include, for example, the processor 120 of the server 106 using the outputs of the final transformer encoder layers 214n and 226n to generate object scores 244 and using the outputs of the final transformer encoder layers 214n and 238n to generate attribute scores 246. The pre-trained vision-language model is trained during the prompt tuning to select one of the attribute labels and one of the object labels that match content contained in the image at step 716. This may include, for example, the processor 120 of the server 106 selecting the object label 222 associated with the highest object score 244 and selecting the attribute label 234 associated with the highest attribute score 246.

The pre-trained (and now tuned) vision-language model may be used in any suitable manner. For example, the trained vision-language model may be stored, output, or used at step 718. This may include, for example, the processor 120 of the server 106 storing the vision-language model and using the vision-language model during inferencing. This may also or alternatively include the server 106 deploying the vision-language model to one or more other devices (such as the electronic device 101) for inferencing.

Although FIG. 7 illustrates one example of a method 700 for training a machine learning model to support zero-shot compositional learning, various changes may be made to FIG. 7. For example, while shown as a series of steps, various steps in FIG. 7 may overlap, occur in parallel, occur in a different order, or occur any number of times (including zero times).

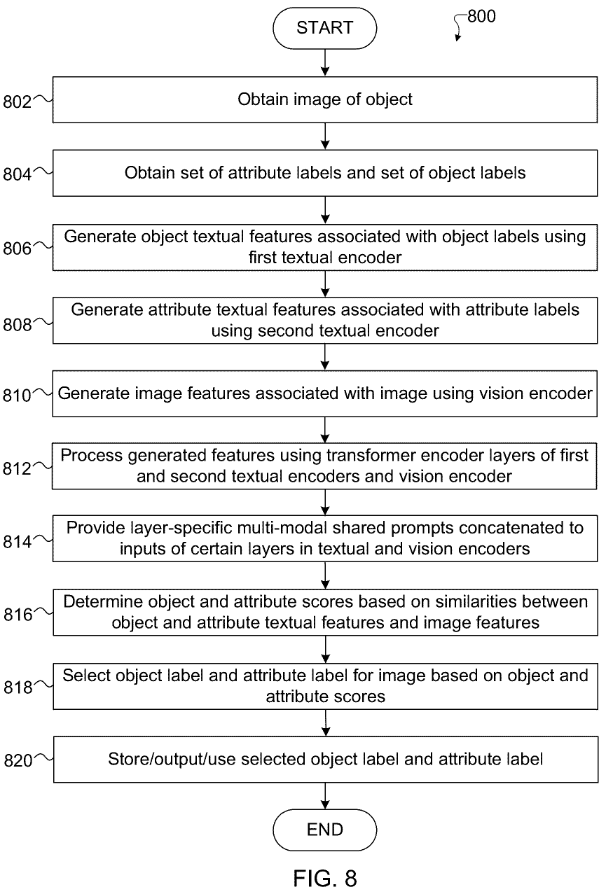

FIG. 8 illustrates an example method 800 for using a machine learning model trained to perform zero-shot compositional learning according to this disclosure. For ease of explanation, the method 800 is described as being performed by the electronic device 101 in the network configuration 100 shown in FIG. 1 using the architecture 200 shown in FIG. 2. However, the method 800 may be performed using any other suitable device(s) (such as the server 106) and in any other suitable system(s), and the method 800 may be used with any other suitable machine learning architecture.

As shown in FIG. 8, an image of an object is obtained at step 802. This may include, for example, the processor 120 of the electronic device 101 obtaining at least one image 208 from at least one imaging sensor 180 or other suitable source. A set of attribute labels and a set of object labels are obtained at step 804. This may include, for example, the processor 120 of the electronic device 101 obtaining the input 220 that includes or identifies the set of object labels 222 and the input 232 that includes or identifies the set of attribute labels 234.

Object textual features associated with each object label are generated using a first textual encoder of a vision-language model at step 806, and attribute textual features associated with each attribute label are generated using a second textual encoder of the vision-language model at step 808. This may include, for example, the processor 120 of the electronic device 101 using the first textual encoder implemented by the branch 204 of the architecture 200 to generate object textual features 224 from the set of object labels 222. This may also include the processor 120 of the electronic device 101 using the second textual encoder implemented by the branch 206 of the architecture 200 to generate attribute textual features 236 from the set of attribute labels 234. Image features associated with the image are generated using a vision encoder of the vision-language model at step 810. This may include, for example, the processor 120 of the electronic device 101 using the vision encoder implemented by the branch 202 of the architecture 200 to generate visual features 212 from the image 208.

The generated features are processed using transformer encoder layers of the textual and vision encoders at step 812. This may include, for example, the processor 120 of the electronic device 101 processing the visual features 212 using the transformer encoder layers 214a-214n of the branch 202, processing the object textual features 224 using the transformer encoder layers 226a-226n of the branch 204, and processing the attribute textual features 236 using the transformer encoder layers 238a-238n of the branch 206. As part of the processing, layer-specific multi-modal shared prompts are concatenated to inputs of specified layers in the textual and vision encoders at step 814. This may include, for example, the processor 120 of the electronic device 101 using the techniques described above to generate shared prompts 218, 230, and 242, which can be provided to the transformer encoder layers 214a-214k, 226a-226k, 238a-238k in each of the branches 202, 204, 206.

Object scores are generated based on similarities between the object textual features and the image features, and attribute scores are generated based on similarities between the attribute textual features and the image features at step 816. This may include, for example, the processor 120 of the electronic device 101 using the outputs of the final transformer encoder layers 214n and 226n to generate object scores 244 and using the outputs of the final transformer encoder layers 214n and 238n to generate attribute scores 246. One of the attribute labels and one of the object labels are selected at step 818. This may include, for example, the processor 120 of the electronic device 101 selecting the object label 222 and the attribute label 234 whose associated object and attribute scores 244, 246 when multiplied generate the largest product.

The selected object and attribute labels may be used in any suitable manner. For example, the selected object and attribute labels may be stored, output, or used at step 820. This may include, for example, the processor 120 of the electronic device 101 using the selected object and attribute labels 222, 234 to identify and perform (or initiate performance of) one or more actions based on the selected object and attribute labels 222, 234. Examples of ways in which the selected object and attribute labels 222, 234 can be used are described above with reference to FIGS. 3 through 6, although the selected object and attribute labels 222, 234 may be used in any other suitable manner.

Although FIG. 8 illustrates one example of a method 800 for using a machine learning model trained to perform zero-shot compositional learning, various changes may be made to FIG. 8. For example, while shown as a series of steps, various steps in FIG. 8 may overlap, occur in parallel, occur in a different order, or occur any number of times (including zero times).

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining an image, a set of attribute labels, and a set of object labels; and
performing prompt tuning of a pre-trained vision-language model comprising a first textual encoder, a second textual encoder, and a vision encoder, the pre-trained vision-language model trained during the prompt tuning to select one of the attribute labels and one of the object labels that match content contained in the image;
wherein performing the prompt tuning comprises, for each of multiple attribute label-object label pairs:
generating object textual features associated with the object label of the attribute label-object label pair using the first textual encoder;
generating attribute textual features associated with the attribute label of the attribute label-object label pair using the second textual encoder; and
generating image features associated with the image using the vision encoder;
wherein intermediate outputs from initial layers of the first textual encoder, the second textual encoder, and the vision encoder are combined to generate layer-specific learnable prompt tokens that are appended to inputs of specified layers in the first textual encoder, the second textual encoder, and the vision encoder during the prompt tuning.

2. The method of claim 1, wherein:
the pre-trained vision-language model is trained during the prompt tuning using multiple images containing objects associated with a subset of the attribute label-object label pairs; and
the pre-trained vision-language model after the prompt tuning is configured to evaluate additional images in a zero-shot manner and identify objects within the additional images associated with attribute label-object label pairs not seen during the prompt tuning.

3. The method of claim 1, wherein performing the prompt tuning further comprises:
determining object scores based on similarities between the object textual features and the image features;
determining attribute scores based on similarities between the attribute textual features and the image features; and
tuning prompts of the pre-trained vision-language model based on the object scores and the attribute scores.

4. The method of claim 1, wherein:
the vision encoder processes the image with learnable visual prompts added to the image during the prompt tuning; and
the pre-trained vision-language model is trained during the prompt tuning to consider each combination of an attribute label from the set of attribute labels and an object label from the set of object labels when identifying the content contained in the image.

5. The method of claim 1, wherein:
the pre-trained vision-language model comprises a transformer-based machine learning model having three branches of transformer layers;
a first of the branches of transformer layers implements the first textual encoder;
a second of the branches of transformer layers implements the second textual encoder; and
a third of the branches of transformer layers implements the vision encoder.

6. The method of claim 5, wherein:
one or more initial visual patch prompts are generated at one or more random positions in the image;
one or more initial textual prompts are generated using a set of known textual categories;
the initial visual and textual prompts are projected for at least one of the transformer layers in each of the branches to generate layer-specific initial prompt tokens, different branches associated with different layer-specific initial prompt tokens; and
in each branch of the transformer-based machine learning model:
each of one or more initial layers in the branch receives one or more of the layer-specific initial prompt tokens and generates one or more embeddings using the one or more layer-specific initial prompt tokens; and
each of one or more subsequent layers in the branch receives one or more embeddings and one or more prompts from a preceding layer in the branch.

7. The method of claim 1, wherein:
the first and second textual encoders represent separate machine learning classifiers;
the machine learning classifiers are trained jointly using a loss function that combines losses associated with the machine learning classifiers; and
the machine learning classifiers are used to select the one of the attribute labels and the one of the object labels by identifying an attribute label-object label combination having a highest score.

8. An apparatus comprising:
at least one processing device configured to:
obtain an image, a set of attribute labels, and a set of object labels; and
perform prompt tuning of a pre-trained vision-language model comprising a first textual encoder, a second textual encoder, and a vision encoder, the pre-trained vision-language model trained during the prompt tuning to select one of the attribute labels and one of the object labels that match content contained in the image;
wherein, to perform the prompt tuning, the at least one processing device is configured, for each of multiple attribute label-object label pairs, to:
generate object textual features associated with the object label of the attribute label-object label pair using the first textual encoder;
generate attribute textual features associated with the attribute label of the attribute label-object label pair using the second textual encoder; and
generate image features associated with the image using the vision encoder;
wherein the at least one processing device is configured to combine intermediate outputs from initial layers of the first textual encoder, the second textual encoder, and the vision encoder to generate layer-specific learnable prompt tokens that are appended to inputs of specified layers in the first textual encoder, the second textual encoder, and the vision encoder during the prompt tuning.

9. The apparatus of claim 8, wherein, to perform the prompt tuning, the at least one processing device is further configured to:
determine object scores based on similarities between the object textual features and the image features;
determine attribute scores based on similarities between the attribute textual features and the image features; and
tune prompts of the pre-trained vision-language model based on the object scores and the attribute scores.

10. The apparatus of claim 8, wherein:
the vision encoder is configured to process the image with learnable visual prompts added to the image during the prompt tuning; and
the pre-trained vision-language model is trained during the prompt tuning to consider each combination of an attribute label from the set of attribute labels and an object label from the set of object labels when identifying the content contained in the image.

11. The apparatus of claim 8, wherein:
the pre-trained vision-language model comprises a transformer-based machine learning model having three branches of transformer layers;
a first of the branches of transformer layers implements the first textual encoder;
a second of the branches of transformer layers implements the second textual encoder; and
a third of the branches of transformer layers implements the vision encoder.

12. The apparatus of claim 11, wherein:
the at least one processing device is further configured to:
generate one or more initial visual patch prompts at one or more random positions in the image;
generate one or more initial textual prompts using a set of known textual categories; and
project the initial visual and textual prompts for at least one of the transformer layers in each of the branches to generate layer-specific initial prompt tokens, different branches associated with different layer-specific initial prompt tokens; and
in each branch of the transformer-based machine learning model:
each of one or more initial layers in the branch is configured to receive one or more of the layer-specific initial prompt tokens and generate one or more embeddings using the one or more layer-specific initial prompt tokens; and
each of one or more subsequent layers in the branch is configured to one or more embeddings and one or more prompts from a preceding layer in the branch.

13. The apparatus of claim 8, wherein:
the first and second textual encoders represent separate machine learning classifiers;
the at least one processing device is configured to jointly train the machine learning classifiers using a loss function that combines losses associated with the machine learning classifiers; and
the machine learning classifiers are configured to select the one of the attribute labels and the one of the object labels by identifying an attribute label-object label combination having a highest score.

14. A method comprising:
obtaining an image of an object;
obtaining a set of attribute labels and a set of object labels; and
selecting one of the attribute labels and one of the object labels associated with the object using a vision-language model comprising a first textual encoder, a second textual encoder, and a vision encoder;
wherein selecting the one of the attribute labels and the one of the object labels associated with the object comprises:
generating object textual features associated with each of the object labels using the first textual encoder;
generating attribute textual features associated with each of the attribute labels using the second textual encoder; and
generating image features associated with the image using the vision encoder;
wherein one or more layers in the first textual encoder, one or more layers in the second textual encoder, and one or more layers in the vision encoder are each associated with a layer-specific multi-modal shared prompt that is concatenated to an input for the layer.

15. The method of claim 14, wherein selecting the one of the attribute labels and the one of the object labels associated with the object further comprises:
for each object label, determining an object score based on a similarity between the image features generated by a final layer of the vision encoder and the object textual features associated with the object label generated by a final layer of the first textual encoder;
selecting the object label associated with a highest object score;
for each attribute label, determining an attribute score based on a similarity between the image features generated by the final layer of the vision encoder and the attribute textual features associated with the attribute label generated by a final layer of the second textual encoder; and
selecting the attribute label associated with a highest attribute score.

16. The method of claim 14, further comprising:
performing at least one action based on the selected object label and the selected attribute label.

17. The method of claim 16, wherein:
the image comprises an image of food cooking or to be cooked;
the selected attribute label and the selected object label are associated with a current state of a specific type of food; and
the at least one action comprises controlling cooking of the food, controlling a notification of cooking status, or both based on the selected attribute label and the selected object label.

18. The method of claim 16, wherein:
the image comprises an image of different foods;
one of the attribute labels and one of the object labels are selected for each of the different foods; and
the at least one action comprises generating at least one recipe based on the selected attribute labels and the selected object labels for the different foods.

19. The method of claim 16, wherein:
the image comprises an image of clothing;
the selected attribute label and the selected object label are associated with a material type for a specific type of clothing; and
the at least one action comprises controlling cleaning of the clothing based on the selected attribute label and the selected object label.

20. The method of claim 16, wherein:
the object in the image represents a specific type of object in a particular state;
the selected attribute label and the selected object label are associated with the particular state and the specific type of object; and
the at least one action comprises presenting a recommendation associated with the object on a smart device, the recommendation based on the selected attribute label and the selected object label.
